(19) United States
(12) Patent Application Publication
(10) Pub. No.: US 2008/0054111 A1
(43) Pub. Date: Mar. 6, 2008

(54) EXTENDIBLE TOOL

(75) Inventor: Kenneth D. KJENNER, Ponoka (CA)

Correspondence Address: DAVIS BUJOLD & Daniels, P.L.L.C., 112 PLEASANT STREET, CONCORD, NH, 03301, US

(73) Assignee: 909469 ALBERTA LTD., Ponoka (CA)

(21) Appl. No.: 11/846,556

(22) Filed: Aug. 29, 2007

(30) Foreign Application Priority Data
Sep. 6, 2006 (CA) 2559332

(51) Int. Cl. B02C 19/11

(52) U.S. Cl. 241/101.72

(57) ABSTRACT

An extendible tool includes a telescopic cylinder support having a first end and a second end. A telescopic cylinder is mounted on the telescopic cylinder support. The telescopic cylinder has a first position toward the first end of the telescopic cylinder support, and a second position toward the second end of the telescopic cylinder support. The telescopic cylinder is movable between the first position and the second position. A tool is mounted on the telescopic cylinder, such that when the telescopic cylinder is extended in the first position, the tool travels between a first point and a second point, and such that when the telescopic cylinder is extended in the second position the tool travels between the second point and a third point.

### FIELD

The present application relates to an extendible tool.

### BACKGROUND

Canadian Patent No. 2,202,014 describes a rotary bale shredder having a cutter for removing twine from the rotary shaft of the shredder. The cutter is moved manually, and the capacity is therefore limited to the strength of the user.

### SUMMARY

There is provided an extendible tool includes a telescopic cylinder support having a first end and a second end. A telescopic cylinder is mounted on the telescopic cylinder support. The telescopic cylinder has a first position toward the first end of the telescopic cylinder support, and a second position toward the second end of the telescopic cylinder support. The telescopic cylinder is movable between the first position and the second position. A tool is mounted on the telescopic cylinder, such that when the telescopic cylinder is extended in the first position, the tool travels between a first point and a second point, and such that when the telescopic cylinder is extended in the second position the tool travels between the second point and a third point.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a telescopic cylinder.

FIG. 2 is a side elevation view of a telescopic cylinder support.

FIG. 3 is a top plan view of the telescopic cylinder support.

FIG. 4 through 8 are side elevation views of an extendible tool at various stages of being extended.

FIG. 9 is a detailed end elevation view of a track and track engaging member.

FIG. 10 is a side elevation view of a rotary bale shredder.

FIG. 11 is a side elevation view of the extendible tool with a rotary shaft.

### DETAILED DESCRIPTION

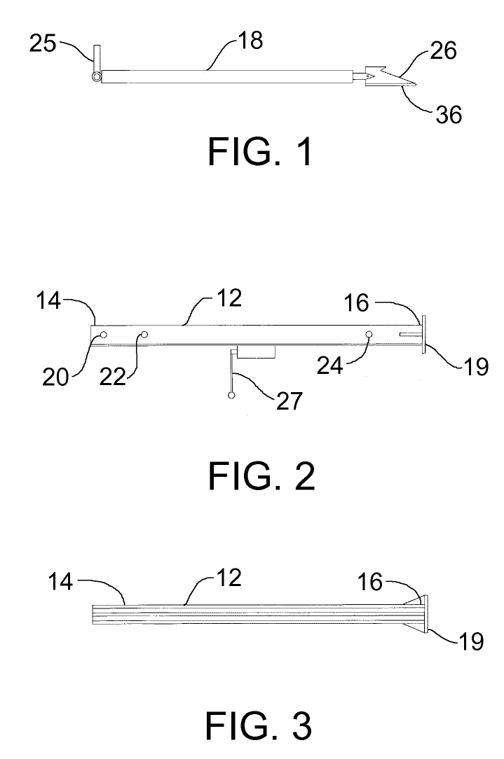

An extendible tool generally identified by reference numeral 10, will now be described with reference to FIG. 1 through 9. A rotary bale shredder generally identified by reference numeral 100 that incorporates extendible tool 10 with then be described with reference to FIGS. 10 and 11.

Structure and Relationship of Parts of the Extendible Tool:

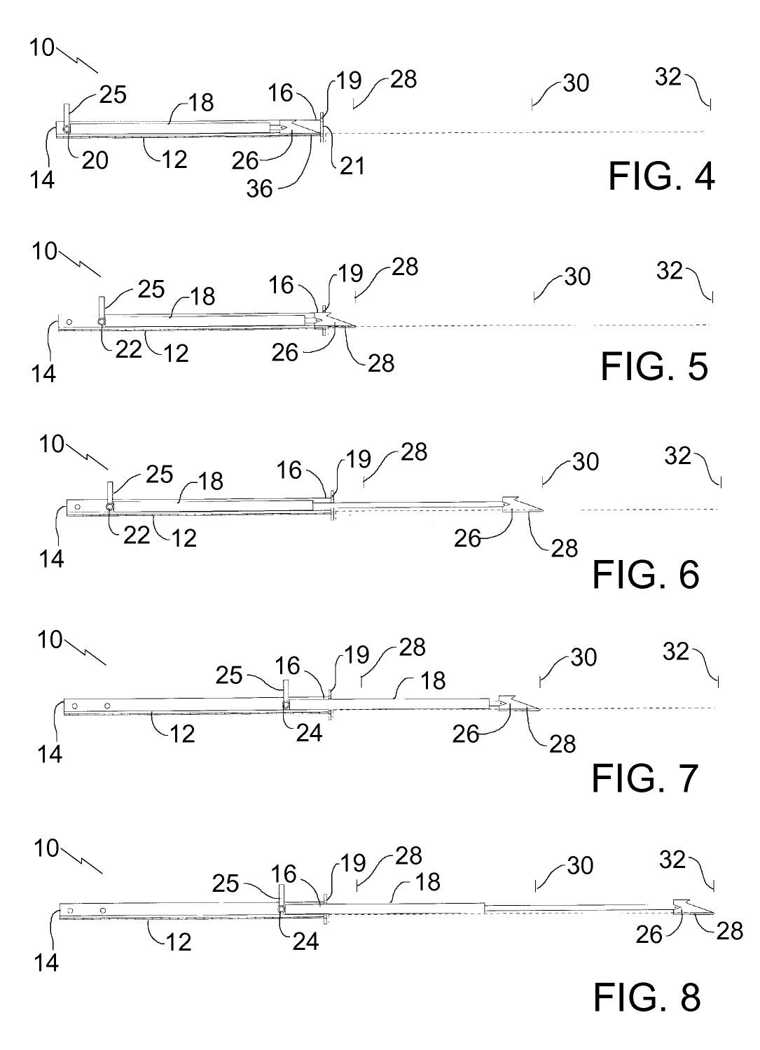

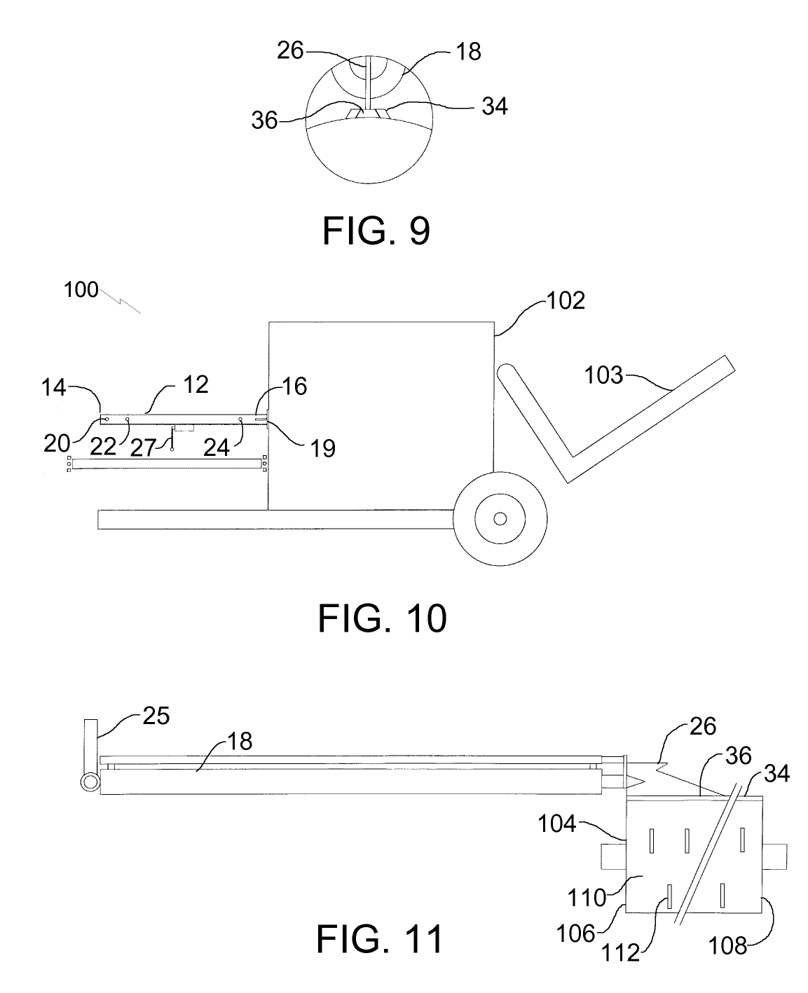

Referring to FIG. 4, extendible tool 10 includes a telescopic cylinder support 12, which has a first end 14 and a second end 16. A telescopic cylinder 18 shown in FIG. 1 is mounted on telescopic cylinder support 12, which is shown in FIGS. 2 and 3. Referring to FIG. 4, telescopic cylinder support 12 may have a mounting plate 19 at second end 16 with a hole 21 to allow telescopic cylinder 18 to extend through it. Referring to FIG. 2, telescopic cylinder 18 (shown in FIG. 1) has a storage position 20 toward first end 14 of telescopic cylinder support 12, a first position 22 toward second end 16 of telescopic cylinder support 12 relative to storage position 20, and a second position 24 toward second end 16 of telescopic cylinder support 12 relative to first position 22. Referring to FIG. 4 through 8, telescopic cylinder 18 is slidably mounted on telescopic cylinder support 12 such that it is able to move between storage position 20, first position 22 and second position 24, and is secured to each position by a pin connection. The position of telescopic cylinder 18 is adjusted using handle 25. A tool, such as a cutting element 26 as shown, is mounted on telescopic cylinder 18. Referring to FIG. 2, telescopic cylinder is extended and retracted using controls 27. Referring to FIGS. 5 and 6, when telescopic cylinder 18 extends in first position 22, cutting element 26 travels between a first point 28 and a second point 30. Referring to FIGS. 7 and 8, when telescopic cylinder 18 is extended in second position 24, cutting element 26 travels between second point 30 and a third point 32. As shown in FIG. 9, a track 34 may also be provided, such that a track engaging member 36 on cutting element 26 travels along track 34.

Operation of the Extendible Tool:

The use and operation of extendible tool 10 described above with reference to FIG. 1 through 9 will now be discussed. Referring to FIG. 4, telescopic cylinder 18 is mounted on telescopic cylinder support 12 in a slidable manner. Telescopic cylinder 18 is positioned in storage position 20 when not in use and held in place using a pin connection. Referring to FIG. 5, telescopic cylinder 18 is then moved up to first position 22 by handle 25. Referring to FIG. 6, cutting element 26, or another tool in different circumstances, is extended by telescopic cylinder through hole 21 in mounting plate 19, and travels from first point 28 to second point 30 as controls 27 shown in FIG. 2 are manipulated. Referring to FIG. 9 cutting element 26 may be supported in its direction of travel by track 34 which guides track engaging member 36 on cutting element 26. Referring to FIG. 7, telescopic cylinder 18 is then moved from first position 22 to second position 24. Referring to FIG. 8, cutting element 26 then travels from second point 30 to third point 32.

Structure and Relationship of Parts of the Rotary Bale Shredder:

Referring to FIGS. 10 and 11, an example of a situation in which extendible tool 10 may be incorporated is a modification of the rotary bale shredder as described in Canadian Patent No. 2,202,014. Rotary bale shredder 100 includes a bale receiving cradle 102 which is loaded by a bale loader 103, and a rotary shaft 104 positioned in close proximity to bale receiving cradle 102. Rotary shaft 104 has a first end 106, a second end 108, and an exterior surface 110. A plurality of cutting blades 112 are mounted on rotary shaft 104, such that as rotary shaft 104 rotates, cutting blades 112 shred a bale (not shown) positioned on bale receiving cradle 102. Track 34 is positioned along exterior surface 110 between first end 106 and second end 108 of rotary shaft 104, with counterbalancing means secured to shaft 104 to maintain concentric shaft rotation, such that cutting element 26 with track engaging member 36 is positionable in track 34. The means for moving cutting element 26 along track 34 to sever twine that is wrapped around rotary shaft 104 that is used as described above, with telescopic cylinder support 12, is mounted adjacent and parallel to rotary shaft 104 using mounting plate 19, such that second end 16 is positioned adjacent to rotary shaft 104.

Operation of the Rotary Bale Shredder:

Referring to FIG. 10, bale receiving cradle 102 of rotary bale shredder 100 is loaded with a bale using bale loader 103. Rotary shaft 104 then rotates such that cutting blades 112 shred the bale. As this occurs, twine (not shown) becomes wrapped around exterior surface 110 of rotary shaft 104. When it is desired to remove the twine, after one or many bales have been shredded, extendible tool 10 is activated to cause cutting element 26 to travel along rotary shaft 104 in two stages as described above to cut the twine from exterior surface 110 of rotary shaft 104.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. An extendible tool, comprising:
a telescopic cylinder support having a first end and a second end;
a telescopic cylinder mounted on the telescopic cylinder support, the telescopic cylinder having a first position toward the first end of the telescopic cylinder support, and a second position toward the second end of the telescopic cylinder support, the telescopic cylinder being movable between the first position and the second position; and
a tool mounted on the telescopic cylinder, such that when the telescopic cylinder is extended in the first position, the tool travels between a first point and a second point, and such that when the telescopic cylinder is extended in the second position the tool travels between the second point and a third point.

2. The extendible tool of claim 1, wherein the distance between the first point and the second point is substantially the same as the distance between the second point and the third point, and the distance between the first point and the second point being substantially the same as the distance between the first position and the second position of the telescopic cylinder.

3. The extendible tool of claim 1, further comprising a track, the tool having a track engaging member such that the tool travels along the track.

4. The extendible tool of claim 1, wherein the tool is a cutting element.

5. The extendible tool of claim 4, wherein the telescopic cylinder support is mounted on a rotary bale shredder.

6. The extendible tool of claim 5, wherein the telescopic cylinder is slidably mounted on the telescopic cylinder support between the first position and the second position.

7. The extendible tool of claim 1, wherein the telescopic cylinder is secured to the first position and to the second position by a pin connection.

8. The extendible tool of claim 1, wherein the telescopic cylinder further comprises a storage position toward the first end of the telescopic cylinder support from the first position.

9. An extendible tool, comprising:
a telescopic cylinder support having a first end and a second end;
a telescopic cylinder mounted on the telescopic cylinder support, the telescopic cylinder having a storage position toward first end of the telescopic cylinder support, a first position toward the second end of the telescopic cylinder support relative to the storage position, and a second position toward the second end of the telescopic cylinder support relative to the first position, the telescopic cylinder being slidably mounted on the telescopic cylinder support between the storage position, the first position and the second position, the telescopic cylinder being secured to the storage position, the first position and the second position by a pin connection;
a cutting element mounted on the telescopic cylinder, such that when the telescopic cylinder is extended in the first position, the cutting element travels between a first point and a second point, and such that when the telescopic cylinder is extended in the second position the cutting element travels between the second point and a third point; and
a track, the cutting element having a track engaging member such that the cutting element travels along the track.

10. A method of extending a tool comprising the steps of:
positioning a telescopic cylinder at a first position on a telescopic cylinder support;
extending the telescopic cylinder such that a tool mounted on the telescopic cylinder travels from a first point to a second point;
retracting the telescopic cylinder;
positioning the telescopic cylinder at a second position on the telescopic cylinder support; and
extending the telescopic cylinder such that the tool mounted on the telescopic cylinder travels from the second point to a third point.

11. The method of claim 10, wherein the distance between the first point and the second point is substantially the same as the distance between the first position and the second position of the telescopic cylinder on the telescopic cylinder support and is substantially the same as the distance between the second position and the third position.

12. The method of claim 10, wherein the tool travels along a track, the tool having a track engaging member.

13. The method of claim 10, wherein the tool is a cutting element.

14. The method of claim 13, further comprising the step of mounting the telescopic cylinder support on a rotary bale shredder.

15. The method of claim 10, wherein positioning the telescopic cylinder at the first position on the telescopic cylinder support comprises positioning the telescopic cylinder at the first position on a telescopic cylinder support.

16. The extendible tool of claim 15, wherein positioning the telescopic cylinder at the first position and the second position comprises sliding the telescopic cylinder along the telescopic cylinder support.

17. The method of claim 10, wherein the positioning the telescopic cylinder at the first position and the second position comprises securing the telescopic cylinder by a pin connection.

18. The method of claim 10, further comprising the step of positioning the telescopic cylinder in a storage position toward the first end of the telescopic cylinder support from the first position.

19. A rotary bale shredder, comprising:
a bale receiving cradle;
a rotary shaft positioned in close proximity to the bale receiving cradle, the rotary shaft having a first end, a second end, and an exterior surface;
a plurality of cutting blades mounted on the rotary shaft, such that as the rotary shaft rotates, the cutting blades shred a bale positioned on the bale receiving cradle;
a track along the exterior surface between the first end and the second end of the rotary shaft, with counterbalancing means secured to the shaft to maintain concentric shaft rotation, such that a cutting knife with track engaging means is positionable in the track; and
means for moving the cutting knife along the track thereby severing twine that is wrapped around the rotary shaft, the means comprising:
a telescopic cylinder support mounted adjacent and parallel to the rotary shaft, the telescopic cylinder support having a first end and a second end positioned adjacent to the rotary shaft;
a telescopic cylinder mounted on the telescopic cylinder support, the telescopic cylinder having a first position toward the first end of the telescopic cylinder support, and a second position toward the second end of the telescopic cylinder support, the telescopic cylinder being movable between the first position and the second position;
an actuator controlled by the telescopic cylinder, the actuator travelling along the rotary shaft when actuated; and
a tool mounted on the actuator, such that the tool travels substantially along a first half of the track when the telescopic cylinder is in the first position, and such that the tool travels substantially along a second half of the track when the telescopic cylinder is in the second position.
